(19) United States
(12) Patent Application Publication
(10) Pub. No.: US 2007/0013822 A1
(43) Pub. Date: Jan. 18, 2007

(54) Display device and method of manufacturing the same

(75) Inventors: Yasushi Kawata, Saitama-ken (JP); Akio Murayama, Saitama-ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 11/364,209

(22) Filed: Mar. 1, 2006

(30) Foreign Application Priority Data
Jul. 15, 2005 (JP) 2005-206614

(51) Int. Cl. G02F 1/136

(52) U.S. Cl. 349/41

(57) ABSTRACT

Liquid crystal material 4 is held between first and second substrates 2 and 3 to form pixel portion 5 which include glass plates 10 and 11, respectively. The upper surface of first substrate 2 opposite to second substrate 3 includes a chip mounting portion on which IC chip 6 is mounted to drive liquid crystal material 4. The upper surface of IC chip 6 mounted on semiconductor chip mounting portion 20 and that of second substrate 3 are simultaneously lapped until the upper surface of IC chip 6 becomes the same in height and in plane as that of second substrate 3.

### CROSS-REFERENCE OF RELATED APPLICATIONS

This application is based upon and claims the benefit of priority from the prior Japanese Patent Application No. 2005-206614, filed on Jul. 15, 2005, the entire contents of which are incorporated herein by reference.

### FIELD OF THE INVENTION

This invention generally relates to a chip-on-glass structured display device and a method of manufacturing the same.

### BACKGROUND OF THE INVENTION

Since it is well known that liquid crystal display (LCD), electro-luminescence display (ELD) or light-emitting diode display (LED) devices have the advantages of light weight, thin thickness, low power consumption and the like, such LCD, ELD or LED devices have been used for many applications, such as office automation equipment, clocks, television receivers, etc. LCD, ELD or LED devices provided with thin-film-transistor (TFT) devices as active elements are particularly so good for response that such LCD, ELD or LED devices have been applied to image display units for portable television receivers, display monitors for personal computers and the like.

Further, much thinner and lighter LCD, ELD or LED panels have been required for small size and mobile equipment such as mobile personal computers, personal digital assistance devices, cellular phones, etc. from view points of improvements in the function of portability and in appearance design. Glass substrates for such LCD, ELD or LED panels, however, are easily deformed if the thickness is not larger than 0.2 mm. As a result, if outer stress is applied to the glass substrates, outer stress is absorbed by their deformation so that possible breakage of the glass substrates may be avoided. Thus, thinner display panels are especially promising from that aspect.

Since chip-on-glass (COG) structured LCD or ELD devices have integrated circuit (IC) semiconductor chips disposed on the glass substrates to drive display panels, the LCD, ELD or LED devices become thicker than the glass substrates and have the disadvantages of limitations of functionality and appearance design.

### SUMMARY OF THE INVENTION

The present invention is directed to a display device and a method of manufacturing the same that is thinner in thickness and lighter in weight. The present invention is also directed to a display device and a method of manufacturing the same, the structure of which may prevent a panel from breaking if outer stress is applied to the panel. The present invention is further directed to a display device and a method of manufacturing the same that can improve functionality of components disposed on the display device.

In accordance with one aspect of the present invention, a display device is provided with a substrate having a semiconductor device mounting portion, pixels, and a semiconductor device mounted on the semiconductor device mounting portion to drive the pixels, the semiconductor device including conductive portions, wherein height and plane of an upper surface of the semiconductor device are substantially equal to those of the display device.

In accordance with another aspect of the present invention, a method of manufacturing a display device carries out preparing a substrate having a semiconductor device mounting portion and pixels, mounting a semiconductor device on the semiconductor device mounting portion to drive the pixels, the semiconductor device including conductive portions, and making height and plane of an upper surface of the semiconductor device substantially equal to those of the display device.

According to the present invention, a display device is thinner in thickness and lighter in weight but still can absorb outer stress, even if applied to the display device, so that its panel is prevented from breaking and so that the functionality of components used and an overall appearance design of the display device can improve significantly.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a plan view of a first substrate in accordance with a first embodiment of the present invention;

FIG. 2 is a longitudinally sectional view of a part of a cell unit in accordance with the first embodiment of the present invention;

FIG. 3 is a cross-sectional view of a strip cell unit in accordance with the first embodiment of the present invention;

FIG. 4 is a longitudinally sectional view of a strip cell unit on which an IC chip is mounted in accordance with the first embodiment of the present invention;

FIG. 5 is a plan view of an LCD device in accordance with the first embodiment of the present invention;

FIG. 6 is a longitudinally sectional view of the LCD device in accordance with the first embodiment of the present invention;

FIG. 7 is a longitudinally sectional view of a modification of the LCD device in accordance with the first embodiment of the present invention;

FIG. 8 is a plan view of a single cell in accordance with a second embodiment of the present invention;

FIG. 9 is a longitudinally sectional view of a strip cell unit on which an IC chip is mounted in accordance with the second embodiment of the present invention;

FIG. 10 is a longitudinally sectional view of an LCD device in accordance with the second embodiment of the present invention; and

FIG. 11 is a plan view of the LCD device in accordance with the second embodiment of the present invention.

### DETAILED DESCRIPTION OF THE INVENTION

Embodiments of the present invention will be explained below with reference to the attached drawings. It should be noted that the present invention is not limited to the embodiments but covers their equivalents. Throughout the attached drawings, similar or same reference numerals show similar, equivalent or same components. The drawings, however, are shown schematically for the purpose of explanation so that their components are not necessarily the same in shape or dimension as actual ones. In other words, concrete shapes or dimensions of the components should be considered as described in these specifications, not in view of the ones shown in the drawings. Further, some components shown in the drawings may be different in dimension or ratio from each other.

### First Embodiment

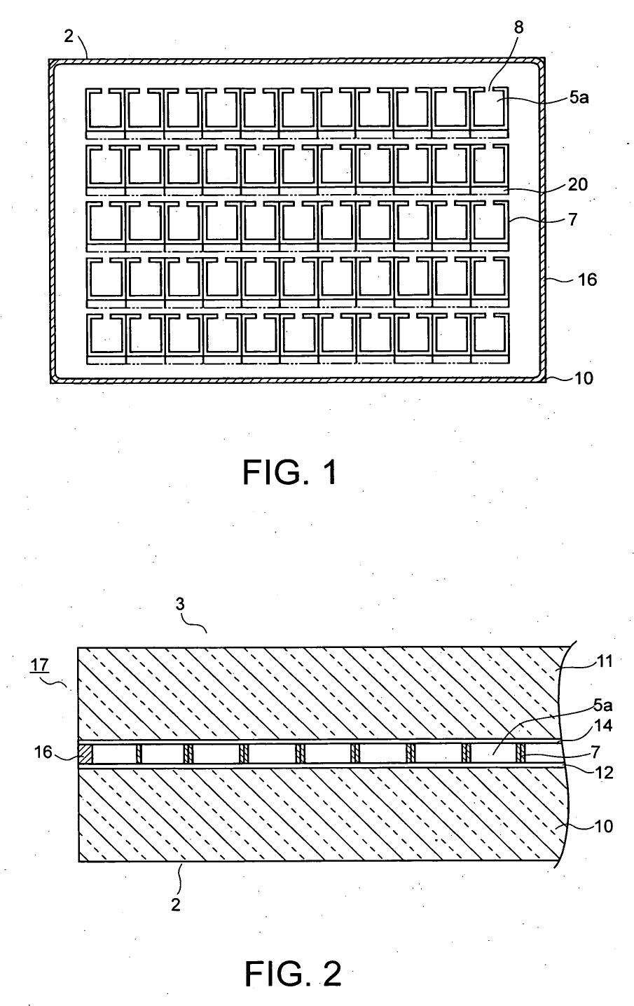

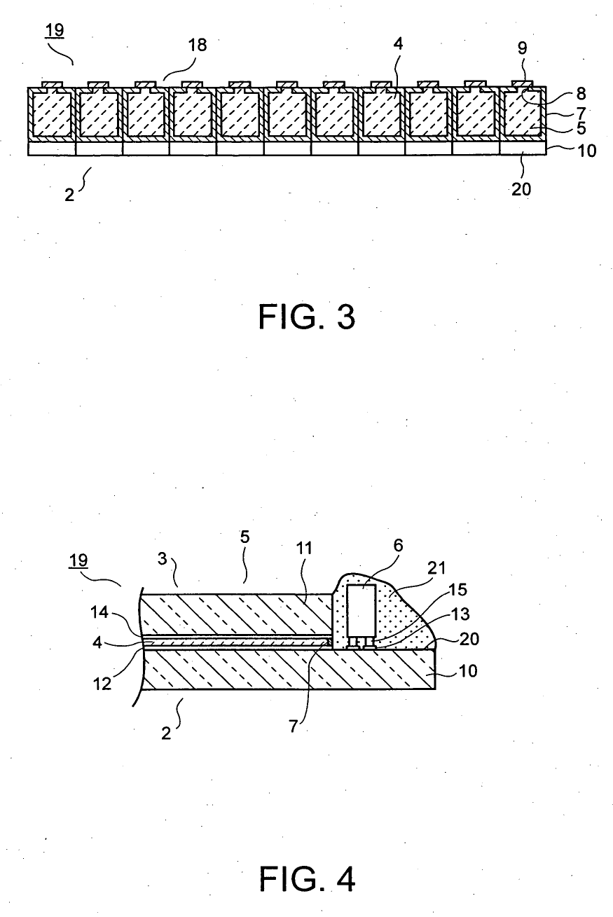

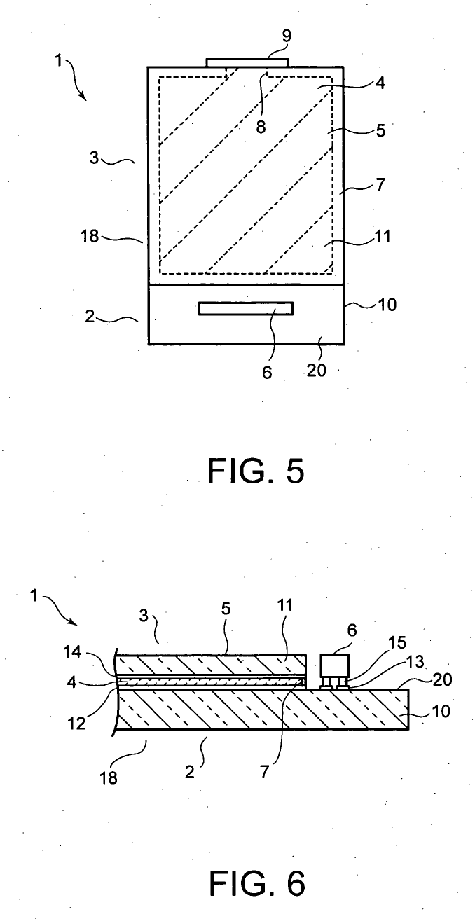

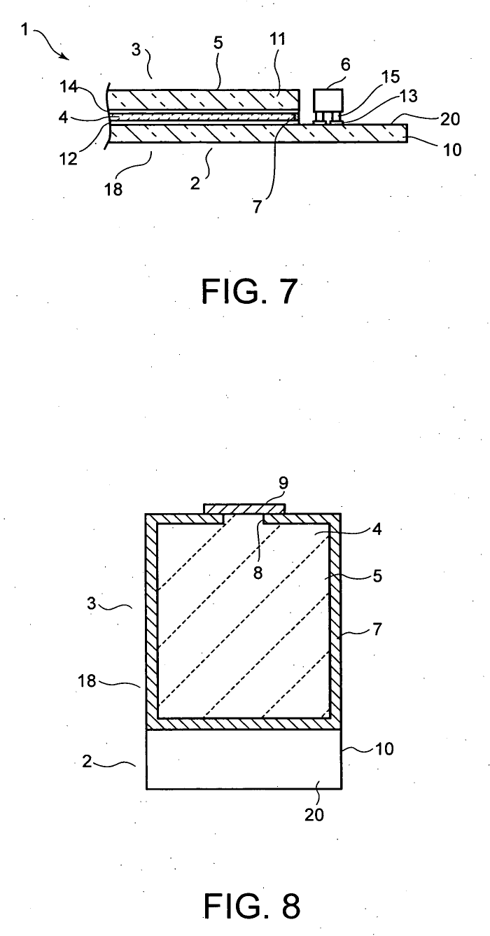

A first embodiment in accordance with the present invention will be described with reference to FIGS. 1-7 below. FIG. 1 is a plan view of a first substrate. FIG. 2 is a longitudinally sectional view of a part of a cell unit. FIG. 3 is a cross-sectional view of a strip cell unit. FIG. 4 is a longitudinally sectional view of a strip cell unit in which an IC chip is installed. FIG. 5 is a plan view of an LCD device. FIG. 6 is a longitudinally sectional view of the LCD device. FIG. 7 is a longitudinally sectional view of a modification of the LCD device.

LCD device 1 of this embodiment has a rectangular display panel which is several cm wide by several cm long (a 5 cm×5 cm rectangular panel, for instance) and which is used for a cellular phone or the like. As shown in FIGS. 4 and 5, LCD device 1 includes pixel portion 5 and IC chip 6 mounted on semiconductor chip mounting portion 20. Pixel portion 5 is provided with first and second substrates 2 and 3 and liquid crystal material 4 held between the upper surface of first substrate 2 and the lower surface of second substrate 3. Spacers or columns not shown in the drawings are disposed between first and second substrate 2 and 3 to define a space in pixel portion 5 while thermal setting epoxy resin sealant 7 is provided around the circumference of pixel portion 5 for partition. Liquid crystal material 4 is filled in such a space through injection aperture 8, which is in turn sealed with ultraviolet setting epoxy resin sealant 9.

First and second substrates 2 and 3 fixed with sealant 7 have substrate bodies made of non-alkaline white glass plates 10 and 11 which are transparent for visible light. On the upper portion of first substrate 2, first component layer 12 is provided with active elements of thin-film-transistor (TFT) devices which are not shown in the drawings but correspond to pixel 5, wiring components, display electrodes, capacitors, etc. and electrode pad 13 is formed on semiconductor chip mounting portion 20. On the lower portion of second substrate 3, on the other hand, second component layer 14 is provided with color filters, common electrodes, alignment layers, etc.

Substrate body glass plate 10 of first substrate 2 is 0.3 mm in thickness. Substrate body glass plate 11 of second substrate 3, however, is not thicker than 0.2 mm, e.g., 0.1 mm. Polarizers not shown in the drawings are set to the rear and front surfaces of first and second substrates 2 and 3.

The upper surface of IC chip 6 mounted on LCD device 1 is the same in height as that of second substrate 3 fixed on first substrate 2 with sealant 7.

When LCD device 1 is used for a display panel, glass plate 11 of second substrate 3 is placed on a display side. Since glass plate 11 is 0.1 mm in thickness, i.e., less than 0.2 mm, it is not solid but so flexible and deformable that the absorption of outer stress, if applied to LCD device 1 in its manufacturing process, can be easily carried out to prevent glass plate 11 from breaking. Thus, a yield rate of LCD device 1 can be improved. Further, the upper surface of IC chip 6 mounted on first substrate 2 reaches substantially the same height and plane as that of second substrate 3. As a result, the display surface of LCD device 1 is substantially in line with the upper surface of IC chip 6 so that there are substantial improvements in, or no substantial limitations on, the functionality and appearance design of a cellular phone in which LCD device 1 is installed and the degree of freedom in engineering design increases significantly.

Next, manufacturing processes of LCD device 1 will be described below with reference to FIGS. 1-6. Glass plates 10 and 11 are prepared in advance. Each of glass plates 10 and 11 is a non-alkaline white glass member which is transparent for visible light and is 0.7 mm thick by 550 mm long by 650 mm wide, for example. First substrate 2 includes a plurality of pixel portions 5. Pixel portion 5 is formed in a predetermined configuration, such as a rectangle, on glass plate 10. Pixel region 5a of pixel portion 5 includes first component layer 12 composed of TFT devices, wiring components, display electrodes, capacitors, etc. Likewise, second substrate 3 includes second component layer 14 composed of TFT devices, wiring components, display electrodes, capacitors, etc. Second component layer 14 is provided in regions of the rear surface of glass plate 11 corresponding to pixel portions 5 on which color filters, a common electrode, an alignment layer, etc. are formed.

After the preparation for first and second substrates 2 and 3, thermal setting epoxy resin sealant 7 is coated by means of a screen printing method or the like on the front surface of first substrate 2 to partition pixel regions 5a of pixel portions 5 as shown in FIG. 1. Such coating is continuously carried out for sealant 7 to form injection aperture 8 and to seal tightly interiors of units partitioned with predetermined width and thickness of sealant 7. Likewise, predetermined width and thickness of thermal setting epoxy resin sealant 16 are preliminarily coated along all the outer circumference of first substrate 2 on the front surface of first substrate 2 to form a sealing width of about 2 mm.

Silicon oxide (SiO₂) or resin ball spacers are disposed on first substrate 2 coated with sealants 7 and 16 and second substrate 3 is set on first substrate 2, so that a gap ranging from 5 μm to 6 μm, for example, is defined between first and second substrates 2 and 3. First and second substrates 2 and 3 are then heated at a predetermined temperature to harden sealants 7 and 16 to glue first and second substrate 2 and 3 together. Thus, cell unit 17 is formed as shown in FIG. 2.

Next, cell unit 17 with first and second substrates 2 and 3 put together with sealants 7 and 16 is immersed in a strong acid etching solution, such as a hydrogen fluoride solution, to change outer glass surfaces of first and second substrates 2 and 3 to water glass in a second process. When cell unit 17 is immersed in the etching solution, first and second substrates 2 and 3 are shaken to make both outer glass surfaces uniform in etching. When the thickness of each of glass plates 10 and 11 reaches a predetermined value ranging from 0.3 mm to 0.5 mm, e.g., 0.3 mm, first and second substrates 2 and 3 are taken out from the etching solution, washed with water and dried to finish the etching process.

After the etching process, cell unit 17 is divided into a strip cell unit 19 with a series of single cells 18. Each of single cells 18 has apertures 8 of pixel portions 5 cut in line with the same side as shown in FIG. 3 by a well known method, such as a method of using a diamond saw. Liquid crystal material 4 is then injected into a space partitioned by sealant 7 at each single cell 18 of strip cell unit 19 through aperture 8 by vacuum injection method or the like. After the completion of injection of liquid crystal material 4, ultraviolet setting epoxy resin sealant 9 is coated around each aperture 8 by a dispenser method or the like, and ultraviolet light is irradiated to sealant 9, which is in turn hardened to seal up aperture 8.

In a subsequent fourth process, as shown in FIG. 4, IC chip 6 is mounted at semiconductor chip mounting portion 20 of each single cell 18 of strip cell unit 19. Since IC chip 6 ranges from 0.3 mm to 0.5 mm in height, for example, the upper surface of IC chip 6 mounted alone is almost the same in height as, or higher than, that of second substrate 3.

Here, for mounting IC chip 6, a bump of IC chip 6 is set on anisotropic conduction film (AFC) 15 also placed on electrode pad 13 at a predetermined position of semiconductor chip mounting portion 20, and heating at a predetermined temperature and pressure bonding of those components are carried out. Novolac system resist protective material 21 is coated on semiconductor chip mounting portion 20 to cover mounted IC chip 6 as well as conductive portions of electrode pad 13, the bump, etc. Coated semiconductor chip mounting portion 20 is then pre-baked at temperature of 80° C. for 30 seconds to protect IC chip 6, the conductive portions, etc. from contamination at a lapping step of the next process.

Next, in a fifth process, strip cell unit 19 is placed in a lapping machine not shown in the drawings to set the outer surface of second substrate 3 on a lapping surface of the lapping machine. A lapping process is then carried out while abrasive slurry is poured on the lapping surface. Protective material 21 is lapped so that the upper surface of IC chip 6 is eliminated and exposed. Thus, the upper surface of IC chip 6 is lapped together with glass plate 11 of second substrate 3.

This step continues until 0.3 mm thick second substrate 3 and IC chip 6 inclusive become 0.2 mm or less in thickness, e.g., 0.2 mm. Further, while slurry including oxide cerium (CeO₂) used as a polishing material is poured into a polishing surface, a polishing step is carried out until glass plate 11 becomes 0.1 mm in thickness, for example. Similarly, such a polishing step is also applied to IC chip 6 and the outer surface of second substrate 11 is turned into a mirror like surface. As a result, the outer surface of glass plate 11 is the same in height and in plane as the upper surface of IC chip 6.

Next, in a sixth process, protective material 21 of semiconductor chip mounting portion 20 of strip cell unit 19 and 0.1 mm thick glass plate 11 of second substrate 3 are washed with a solvent of acetone, etc., so that protective material 21 is removed from IC chip 6. Strip cell unit 19 with IC chip 6 left but protective material removed is divided into a plurality of single cells 8 mounted with IC chips 6, one of which is shown in FIGS. 5 and 6. Polarizers are then set on both sides of pixel portions 5 of single cell 18 mounted with IC chip 6. Thus, LCD device 1 is composed of 0.1 mm thick display panel glass plate 11 and liquid crystal panel driving IC chip 6, the upper surface of which is the same in height and in plane as the outer surface of glass plate 11.

As described above, according to the first embodiment of this invention, since liquid crystal panel driving IC chip 6 is mounted on semiconductor chip mounting portion 20 of first substrate 2 and is covered with protective material 21 to lap and polish the upper surface of protective material 21 and the outer surface of glass plate 11 of second substrate 3 at the same time, thinner glass plate 11 can be provided, the upper surface of IC chip 6 is easily made the same in height as the outer surface of glass plate 11, first and second substrate 2 and 3 are prevented from being broken and a high production yield rate can be achieved.

In the first embodiment described above, only one surface of strip cell unit 19 is lapped to make glass plate 11 thin to 0.1 mm. As shown in FIG. 7, however, the outer (lower) surface of glass plate 10 of first substrate 2 may also be lapped to make first substrate 2 thinner than 0.3 mm, e.g., 0.1 mm, if necessary, so that both glass plates 10 and 11 can be made thinner.

### Second Embodiment

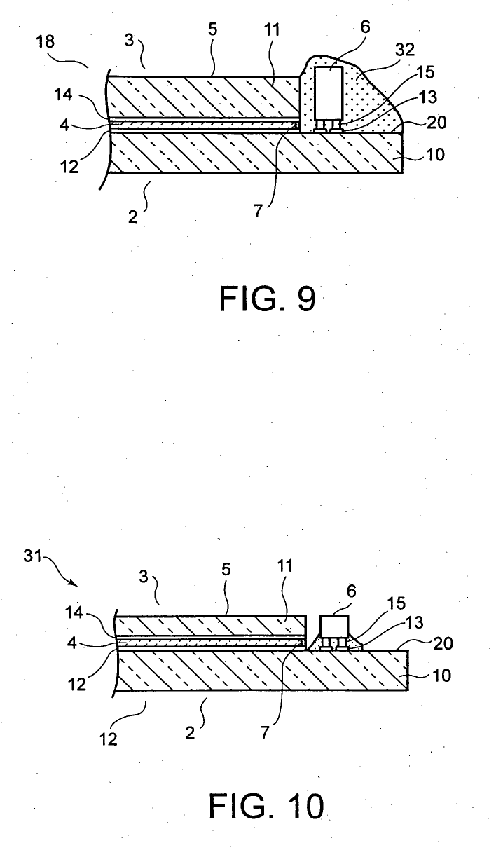

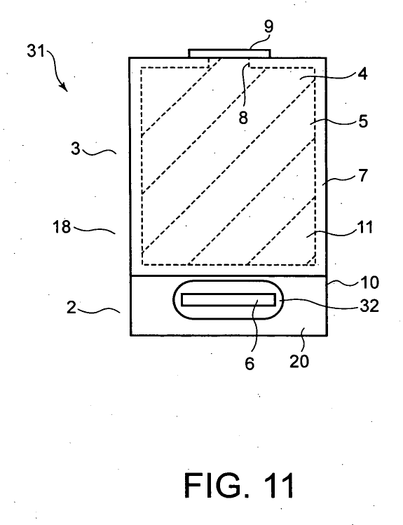

A second embodiment of the present invention will be described with reference to FIGS. 8-11 below. FIG. 8 is a plan view of a single cell. FIG. 9 is a longitudinally sectional view of a strip cell unit on which an IC chip is mounted. FIG. 10 is a longitudinally sectional view of an LCD device. FIG. 11 is a plan view of the LCD device. In the attached drawings, similar or same reference numerals in the second embodiment show similar, equivalent or same components in the first embodiment. Structures different from those of the first embodiment will be primarily explained hereinafter accordingly.

LCD device 31 of the second embodiment includes a several centimeters long by a several centimeters wide rectangular display panel (e.g., 5 cm×5 cm) used for a display panel of a cellular phone or the like, similar to that of the first embodiment. As shown in FIGS. 10 and 11, liquid crystal material 4 is held between first and second substrates 2 and 3 to form pixel portions 5 and liquid crystal panel driving IC chip 6 is mounted on semiconductor chip mounting portion 20 of first substrate 2. Protective material 32 is provided to cover a bump of IC chip 6 mounted on semiconductor chip mounting portion 20 of first substrate 2 and conductive portions of electrode pads 13 at semiconductor chip mounting portion 20 or the like, corresponding to the bump for moisture resistance.

Substrate body glass plate 10 of first substrate 2 is 0.3 mm in thickness. Substrate body glass plate 11 of second substrate 3, however, is not thicker than 0.2 mm, e.g., 0.1 mm. The upper surface of IC chip 6 mounted on semiconductor chip mounting portion 20 is the same in height as that of second substrate 3 so that the upper surface of IC chip 6 is on the same plane as that of second substrate 3.

LCD device 31 set forth above is similar in structure to the first embodiment: second substrate 3 is 0.1 mm in thickness, i.e., not more than 0.2 mm, and the upper surface of IC chip 6 is the same in height as that of second substrate 3. Thus, LCD device 31 is not only the same in effect as the first embodiment but also improves in moisture resistance because protective material 32 covers the conductive portions at semiconductor chip mounting portions 20.

Next, manufacturing processes of LCD device 31 will be described below with reference to FIGS. 1-2 and 8-11. Glass plates 10 and 11 are prepared in advance for the same as the first embodiment. Each of glass plates 10 and 11 is a non-alkaline white glass member which is transparent for visible light and is 0.7 mm thick by 550 mm long by 650 mm wide, for example. First substrate 2 includes a plurality of pixel portions 5 provided in forming pixel region 5a on the upper surface of glass plate 10. First component layer 12 is composed of TFT devices, wiring components, display electrodes, capacitors, etc. Likewise, second substrate 3 includes second component layer 14 composed of TFT devices, wiring components, display electrodes, capacitors, etc. formed on pixel region 5a of pixel portion 5. Second component layer 14 is provided in regions of the rear surface of glass plate 11 corresponding to pixel portions 5 on which color filters, a common electrode, an alignment layer, etc. are formed.

In the first process after the preparation for first and second substrates 2 and 3, thermal setting epoxy resin sealant 7 is coated by means of a screen printing method or the like on the front surface of first substrate 2 to partition pixel regions 5a of pixel portions 5 as shown in FIG. 1. The coating is continuously carried out for sealant 7 to form injection aperture 8 and to seal tightly interiors of units partitioned with predetermined width and thickness of sealant 7. Likewise, thermal setting epoxy resin sealant 16 is preliminarily coated with predetermined width and thickness along all the outer circumference of first substrate 2 on the front surface of first substrate 2 to form a closed loop-like sealing width of about 2 mm.

Silicon oxide (SiO₂) or resin ball spacers are disposed on the upper surface of first substrate 2 coated with sealants 7 and 16 and second substrate 3 is set on first substrate, so that a gap ranging from 5 μm to 6 μm, for example, is defined between first and second substrates 2 and 3. First and second substrates 2 and 3 are then heated at a predetermined temperature to harden sealants 7 and 16 to glue first and second substrate 2 and 3 together. Thus, cell unit 17 is formed as shown in FIG. 2.

In the next second process, cell unit 17 with first and second substrates 2 and 3 put together with sealants 7 and 16 is immersed in a strong acid etching solution, such as a hydrogen fluoride solution, to change outer glass surfaces of first and second substrates 2 and 3 to water glass. When cell unit 17 is immersed in the etching solution, first and second substrates 2 and 3 are shaken to make both outer glass surfaces uniform in etching. When the thickness of each of glass plates 10 and 11 reaches a predetermined value ranging from 0.3 mm to 0.5 mm, e.g., 0.3 mm, first and second substrates 2 and 3 are taken out from the etching solution, washed with water and dried to finish the etching process.

In the third process after the etching process, cell unit 17 is divided into single cell 18 as shown in FIG. 8 by a well known method, such as a method of using a diamond saw. Liquid crystal material 4 is then injected into a space partitioned by sealant 7 at each single cell 18 through injection aperture 8 by a vacuum injection method or the like. After the completion of injection of liquid crystal material 4, ultraviolet setting epoxy resin sealant 9 is coated around each aperture 8 by a dispenser method or the like, and ultraviolet light is irradiated to sealant 9, which is hardened to seal up aperture 8.

In the subsequent fourth process, as shown in FIG. 9, IC chip 6 is mounted on semiconductor chip mounting portion 20 next to pixel portion 5 of single cell 18. Since IC chip 6 ranges from 0.3 mm to 0.5 mm in height, for example, the upper surface of IC chip 6 mounted alone is almost the same in height as, or higher than, that of second substrate 3.

For mounting IC chip 6, a bump of IC chip 6 is set on ACF 15 also placed on electrode pad 13 at a predetermined position of semiconductor chip mounting portion 20, and heating at a predetermined temperature and pressure bonding of those components are carried out in the same way as in the first embodiment. Moisture resist protective material 32 of paraffin or the like is coated on semiconductor chip mounting portion 20 to protect IC chip 6 as well as conductive portions of electrode pad 13, etc. from contamination in the next lapping process.

Next, in the fifth process, strip cell unit 19 is placed in a lapping machine not shown in the drawings to set the outer surface of second substrate 3 on a lapping surface of the lapping machine. A lapping process is subsequently carried out while abrasive slurry is poured on the lapping surface. Protective material 32 is lapped so that the upper surface of IC chip 6 is eliminated and exposed. Thus, the upper surface of IC chip 6 is lapped together with glass plate 11 of second substrate 3.

This lapping step continues until 0.3 mm thick second substrate 3 and IC chip 6 inclusive become 0.2 mm or less in thickness, e.g., 0.2 mm. Further, while slurry including oxide cerium (CeO₂) used as a polishing material is poured into a polishing surface, a polishing step is carried out until glass plate 11 becomes 0.1 mm in thickness, for example. Similarly, such a polishing step is also applied to IC chip 6 and the outer surface of second substrate 3 is turned into a mirror like surface. As a result, the outer surface of glass plate 11 is the same in height and in plane as the upper surface of IC chip 6.

Next, in the sixth process, protective material 32 of semiconductor chip mounting portion 20 of single cell 18 and 0.1 mm thick glass plate 11 of second substrate 3 are washed with a solvent of acetone, etc. so that protective material 32 is removed from IC chip 6. A part of protective material 32, however, is intentionally left to cover the bump of IC chip 6 mounted on semiconductor chip mounting portion 20, its corresponding conductive portions of electrode pad 13 of semiconductor chip mounting portion 20, etc. Polarizers are then set on both sides of pixel portion 5 of single cell 18 mounted with IC chip 6 covered partially with protective material 32. Thus, LCD device 31 is composed of 0.1 mm thick display panel glass plate 11 and liquid crystal panel driving IC chip 6, the upper surface of which is the same in height and in plane as the outer surface of glass plate 11.

With the structure described above, according to the second embodiment of this invention, thinner glass plate 11 can be provided and the upper surface of IC chip 6 is easily made the same in height as the outer surface of glass plate 11, so that the second embodiment can achieve substantially the same effect as the first embodiment.

In each of the embodiments described above, glass plates 10 and 11 of cell unit 17 are thinned with the chemical treatment such as chemical etching. Mechanical treatment such as cutting or lapping can be also applied to thin glass plates 10 and 11. Abrasive slurry of silicon oxide particles, oxide aluminum (Al₂O₃), or the like can be substituted for oxide cerium to carry out the lapping and/or polishing process. Water and chemical resistance materials other than a novolac system resist material or paraffin can be used to prevent the conductive portions from contamination during the lapping or polishing process.

The explanations of the embodiments in accordance with present invention set forth above are primarily directed to certain LCD devices but those skilled in the art can understand that the present invention can be also applied to other than LCD devices, such as ELD or LED devices.

In the foregoing description, certain terms have been used for brevity, clearness and understanding, but no unnecessary limitations are to be implied therefrom beyond the requirements of the prior art, because such words are used for descriptive purposes herein and are intended to be broadly construed. Moreover, the embodiments of the improved construction illustrated and described herein are by way of example, and the scope of the invention is not limited to the exact details of construction. Having now described the invention, the construction, the operation and use of embodiments thereof, and the advantageous new and useful results obtained thereby, the new and useful construction, and reasonable equivalents thereof obvious to those skilled in the art, are set forth in the appended claims.

What is claimed is:

1. A display device comprising:
a first substrate having a semiconductor device mounting portion;
a second substrate provided opposite to the first substrate;
a liquid crystal material held between the first and second substrates to form a pixel portion; and
a semiconductor device mounted on the semiconductor device mounting portion to drive the liquid crystal device, the semiconductor device including conductive portions;
wherein height and plane of an upper surface of the semiconductor device are substantially equal to those of the second substrate.

2. A display device according to claim 1, wherein the second substrate is a glass plate which is not thicker than 0.2 mm.

3. A display device according to claim 1, further comprising a protective material to cover the semiconductor device mounting portion and the conductive portions of the semiconductor device.

4. A display device according to claim 3, wherein the protective material is provided to cover the semiconductor device mounting portion and the conductive portions of the semiconductor device when height and plane of an upper surface of the semiconductor device are made substantially equal to those of the second substrate.

5. A display device according to claim 3, wherein the protective material has moisture resistance.

6. A method of manufacturing a display device comprising:
preparing a first substrate having a semiconductor device mounting portion and a second substrate provided opposite to the first substrate;
filling a gap defined between the first and second substrates with a liquid crystal material to form a pixel portion;
mounting a semiconductor device on the semiconductor device mounting portion to drive the liquid crystal material, the semiconductor device including conductive portions; and
making height and plane of an upper surface of the semiconductor device substantially equal to those of the second substrate.

7. A method of manufacturing a display device according to claim 6, further comprising covering the semiconductor device mounting portion and the conductive portions of the semiconductor device with a protective material when height and plane of an upper surface of the semiconductor device are made substantially equal to those of the second substrate.

8. A method of manufacturing a display device according to claim 6, wherein a part of the protective material is removed after height and plane of an upper surface of the semiconductor device have been made substantially equal to those of the second substrate.

9. A display device comprising:
a substrate having a semiconductor device mounting portion;
pixels; and
a semiconductor device mounted on the semiconductor device mounting portion to drive the pixels, the semiconductor device including conductive portions;
wherein height and plane of an upper surface of the semiconductor device are substantially equal to those of the display device.

10. A display device according to claim 9, wherein the second substrate is a glass plate which is not thicker than 0.2 mm.

11. A display device according to claim 9, further comprising a protective material to cover the semiconductor device mounting portion and the conductive portions of the semiconductor device.

12. A display device according to claim 11, wherein the protective material is provided to cover the semiconductor device mounting portion and the conductive portions of the semiconductor device when height and plane of an upper surface of the semiconductor device are made substantially equal to those of the display device.

13. A display device according to claim 11, wherein the protective material has moisture resistance.

14. A method of manufacturing a display device comprising:
preparing a substrate having a semiconductor device mounting portion;
forming pixels;
mounting a semiconductor device on the semiconductor device mounting portion to drive the pixels, the semiconductor device including conductive portions; and
making height and plane of an upper surface of the semiconductor device substantially equal to those of the display device.

15. A method of manufacturing a display device according to claim 14, further comprising covering the semiconductor device mounting portion and the conductive portions of the semiconductor device with a protective material when height and plane of an upper surface of the semiconductor device are made substantially equal to those of the display device.

16. A method of manufacturing a display device according to claim 14, wherein a part of the protective material is removed after height and plane of an upper surface of the semiconductor device have been made substantially equal to those of the display device.
